(19) United States
(12) Patent Application Publication
(10) Pub. No.: US 2021/0334230 A1
(43) Pub. Date: Oct. 28, 2021

(54) METHOD FOR ACCESSING DATA BUS, ACCESSING SYSTEM, AND DEVICE

(71) Applicant: HON HAI PRECISION INDUSTRY CO., LTD., New Taipei (TW)

(72) Inventor: CHUN-MING LU, New Taipei (TW)

(21) Appl. No.: 16/985,544

(22) Filed: Aug. 5, 2020

(30) Foreign Application Priority Data
Apr. 27, 2020 (CN) 202010345806.X

(51) Int. Cl. G06F 13/362; G06F 13/40

(52) U.S. Cl. CPC G06F 13/3625; G06F 13/4031

(57) ABSTRACT

A method for accessing a data bus includes setting a first-come-first-served basis for determining priorities between masters in addition to a fixed priority being set between the same masters. A number of master ports are connected to a number of masters, and a number of slave ports are connected to a number of slaves. First and second multiplexers are connected between the master ports and the slave ports, a number of decoders are connected to the second multiplexers, and a number of arbiters are connected to the first multiplexers. The master ports have a fixed priority, but each arbiter, in receiving an access-request signal sent by a master port, can determine an order as to which of multiple master ports can access a slave port according to a combination of the fixed priority basis and the first-come-first-served basis. A system and a relevant device are also disclosed.

### FIELD

The disclosure generally relates to data processing technologies, and particularly to a method for accessing data bus, an accessing system, and a device for accessing data bus.

### BACKGROUND

A System on a Chip (SOC) mostly uses a multi-layer Advanced High Performance Bus (AHB) architecture for exchanging information. The AHB specification includes an Advanced Microcontroller Bus Architecture (AMBA) specification and an AHB-Lite protocol. Wherein, the AMBA specification v2.0 defines connections between the AHB multiple layers, and determines switches between multiple masters and multiple slaves by defining arbiters transmitting signals, for example, a bus request signal HBUSREQx and a bus grant signal HGRANTx. The AHB-Lite protocol does not define connections between AHB multiple layers and signals of arbiters, but defines connections between a signal master and multiple slaves, and further defines a selection signal HSEL or type of transmission signal HTRANS instead of the bus request signal HBUSREQx and the bus grant signal HGRANTx to determine switches between the master and multiple slaves.

However, in the above-mentioned process, when the slave is switched to a new master, the pipeline characteristic of the AHB-Lite and AHB multi-layer bus architecture may cause the insertion of a single wait state, causing delay.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a system architecture of one embodiment of a system for accessing data bus.

FIG. 2 is a flowchart of one embodiment of a method for accessing data bus corresponding to the monitoring system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

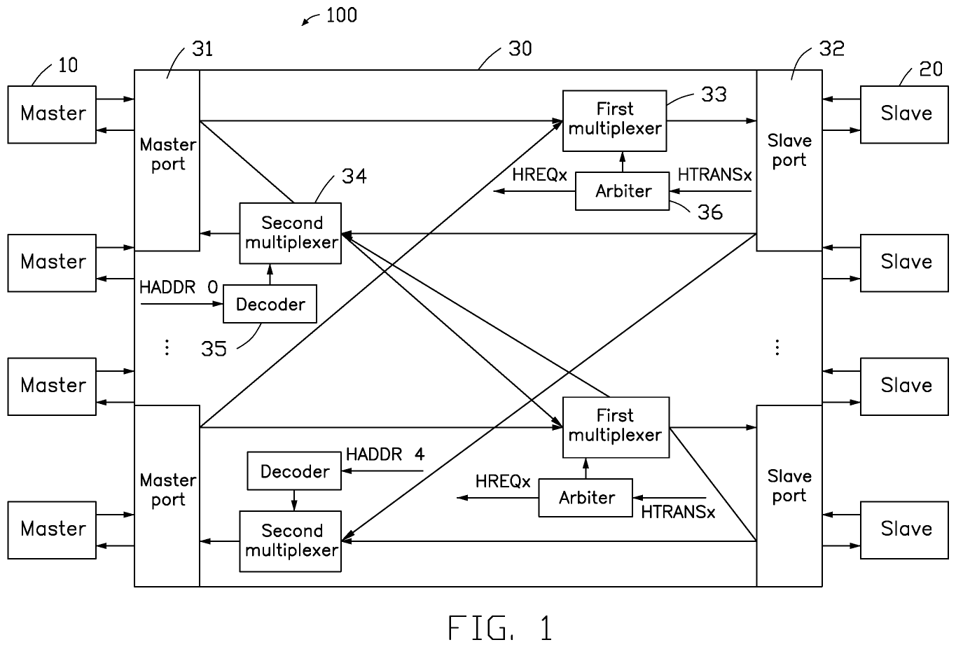

FIG. 1 shows a system architecture of one embodiment of a system 100 for accessing data bus. The system 100 for accessing data bus includes a plurality of masters 10, a plurality of slaves 20, and a device 30 for accessing data bus.

In this embodiment, the device 30 includes a plurality of master ports 31, a plurality of slave ports 32, a plurality of first multiplexers 33, a plurality of second multiplexers 34, a plurality of decoders 35, and a plurality of arbiters 36.

The master ports 31 connect to the masters 10. The slave ports 32 connect to the slaves 20. The slave ports 32 are connected to the master ports 31 through a plurality of data buses. The master ports 31 have a fixed priority for accessing to the slave ports 32. In this embodiment, a master port 31 with a higher priority has the higher priority when accessing to the slave ports 32. Thus, the master port 31 with the higher priority will be granted preferential use of the data buses (i.e. for read or write operation).

The first multiplexers 33 and the second multiplexers 34 are digital multiplexers, connected between the master ports 31 and the slave ports 32. The first multiplexers 33 and the second multiplexers 34 perform switching between the master ports 31 and the slave ports 32.

Each of the decoders 35 is connected to one of the second multiplexers 34. Each of the decoders 35 receives an address signal (for example, HADDR0, HADDR4 shown in FIG. 1) sent by a master port 31 and decodes the address signal to generate a selection signal. The second multiplexer 34 selects the slave port 32 to connect to the master port 31 according to the selection signal.

Each of the arbiters 36 is connected to one of the first multiplexers 33. Each of the arbiters 36 is configured to receive a request signal HREQx sent by a master port 31 and determines an order in which the master ports 31 should have access to the slave port 32 according to a means combined with the fixed priority and a first-come-first-served basis. The request signal HREQx indicates that a master port 31 requests use of the data buses to access the slave port 32.

In this embodiment, when more than one master port 31 simultaneously requests access to the same slave port 32, the arbiter 36 determines the order in which the master ports 31 should have access to the slave port 32 according to the fixed priority. The master port 31 with the higher priority is granted access to the slave port 32.

When more than one master ports 31 request access to the same slave port 32 non-simultaneously, the arbiters 36 determine the order in which the master ports 31 should have access to the slave port 32 according to the first-come-first-served basis. The master port 31 which requested access to the same slave port 32 at the earliest time is granted the higher accessing priority to the slave port 32.

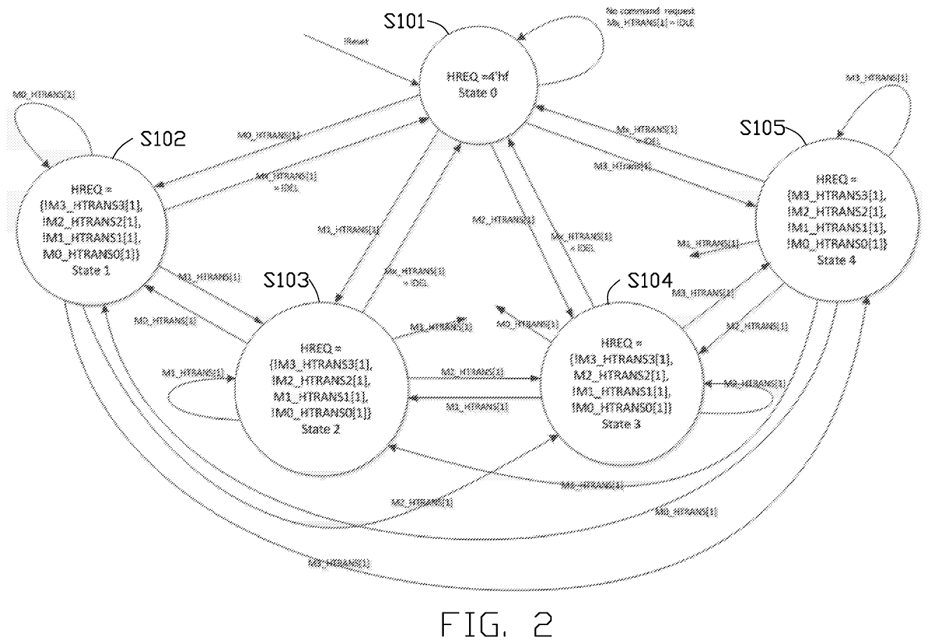

FIG. 2 shows a flowchart of one embodiment of a method for accessing data bus corresponding to the system 100 for accessing data bus of FIG. 1.

In this embodiment, four master ports 31 and four slave ports 32 are taken as an example. The four master ports 31 includes a first master port M0, a second master port M1, a third master port M2, and a fourth master port M3. The fixed priority of the master ports 31 for accessing to the slave ports 32 is in the order the first master port M0>the second master port M1>the third second master port M2>the fourth master port M3.

At block S101, an initial state of each of the arbiters 36 is set. Specifically, the request signal HREQ and the transmission type signal HTRANS of each of the master ports 31 are set. In this embodiment, an initial value of each request signal is set as HREQ=4′hf, which indicates that the number of the master ports 31 is four. The transmission type signal Mx_HTRANS[1] is set as IDEL which indicates that no master port 31 is requesting access to the slave port 32.

At block S102, if the first master port M0, the second master port M1, the third master port M2, and the fourth master port M3 simultaneously request access to the same slave port 32, the arbiter 36 determines the order in which the master ports 31 will have access to the slave port 32 according to the fixed priority. The corresponding request signal HREQ can be {!M3_HTRANS[1], !M2_HTRANS[1], !M1_HTRANS[1], M0_HTRANS[1]} which allows the first master port M0 to have preferential access to the slave port 32, the second master port M1, the third master port M2, and the fourth master port M3 in that order must wait for access to the slave port 32. The arbiter 36 determines that the first master port M0 can preferentially access the slave port 32 until the first master port M0 stops requesting to use the data buses, and the transmission type signal M0_HTRANS[1] is set as IDEL. The arbiter 36 then determines that the second master port M1, the third master port M2, and the fourth master port M3 can access the slave port 32 according to the fixed priority until there is no master port 31 requesting access to the slave port 32, and the transmission type signal Mx_HTRANS[1] is set as IDEL, and the process returns to block S101.

At block S103, if the second master port M1 requests access to the same slave port 32 before the first master port M0, the request signal HREQ is {!M3_HTRANS[1], !M2_HTRANS[1], M1_HTRANS[1], !M0_HTRANS[1]} by which the arbiter 36 determines that the second master 0port M1 can preferentially access the slave port 32 according to the first-come-first-served basis until the second master port M1 stops requesting to use the data buses. The transmission type signal M1_HTRANS[1] is set as IDEL. The arbiter 36 then determines the order in which the first master port M0, the third master port M2, and the fourth master port M3 can access the slave port 32 according to the fixed priority between the master ports 31, until there is no master port 31 requesting access to the slave port 32. The transmission type signal Mx_HTRANS[1] is set as IDEL and the process returns to block S101.

Similarly, at block S104, if the third master port M2 requests access to the same slave port 32 before the first master port M0 and the second master port M1, the request signal HREQ is {!M3_HTRANS[1], M2_HTRANS[1], !M1_HTRANS[1], !M0_HTRANS[1]}. Thereby, the arbiter 36 determines that the third master port M2 can preferentially access the slave port 32 according to the first-come-first-served basis until the third master port M2 stops requesting to use the data buses. The transmission type signal M2_HTRANS[1] is set as IDEL. The arbiter 36 then determines the order in which the first master port M0, the second master port M1, and the fourth master port M3 can access the slave port 32 according to the fixed priority between the master ports 31 until there is no master port 31 requesting access to the slave port 32, the transmission type signal Mx_HTRANS [1] is set as IDEL, and the process returns back to block S101.

At block S105, if the fourth master port M3 requests access to the same slave port 32 before requests are made by the first master port M0, the second master port M1, and the third master port M2, the request signal HREQ is {M3_HTRANS[1], !M2_HTRANS [1], !M1_HTRANS [1], !M0_HTRANS[1]}, by which the arbiter 36 determines that the fourth master port M3 can preferentially access the slave port 32 on the first-come-first-served basis until the fourth master port M3 stops requesting to use the data buses, the transmission type signal M3_HTRANS[1] is set as IDEL. The arbiter 36 then determines the order in which the first master port M0, the second master port M1, and the third master port M2 can have access to the slave port 32 according to the fixed priority between the master ports 31 until there is no master port 31 requesting access to the slave port 32, the transmission type signal Mx_HTRANS[1] is set as IDEL, and the process returns back to block S101.

In other embodiment, when there are N number of the master ports 31, comprising a first master port, a second master port, . . . , until the Nth master port, and corresponding priority levels are a first level, a second level, . . . , until the Nth level (N is an integer), the fixed priority of the master ports 31 for accessing to the slave ports 32 is in the order the first level>the second level>, . . . , >the Nth level, then if the Mth master port (M is an integer equal to or greater than 1 but less than N) requests access to the same slave port 32 before the M−1th master port, the arbiter 36 determines that the Mth master port can preferentially access the slave port 32 on the first-come-first-served basis until the Mth master port stops requesting to use the data bus, and the transmission type signal MK HTRANS[1] is set as IDEL. The arbiter 36 then determines the order in which the first master port, the second master port, . . . , until the M−1th master port, can access the slave port 32 is according to the fixed priority basis until there is no master port 31 requesting access to the slave port 32. The transmission type signal Mx_HTRANS[1] is set as IDEL, and the process returns back to block S101.

The method, the system 100, and the device 30 for accessing the data bus avoid the problems that when the order in which the master ports 31 access to the slave port 32 is determined according to the single fixed priority, data reading and writing efficiency is low due to a master 10 having a lower priority and thus being unable to take access to the data buses for a long time. The instant method also avoids the problem that when the order in which the master ports 31 are taking access to the slave port 32 is determined only upon the single first-come-first-served basis, data reading and writing speed of the master 10 is slow even though it may have a higher priority, which affects an operating efficiency of the system. The method, system 100, and device 30 for accessing the data bus increase data reading and writing efficiency, allows zero waiting states, and reduces delay.

The use of the first multiplexers 33 and the second multiplexers 34 to realize switching between the masters 10 and the slaves 20 increases efficiency of data reading and writing, and renders a timing closure problem less likely.

It is to be understood, however, that even through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A device for accessing data bus comprising:
a plurality of master ports configured to connect to a plurality of masters;
a plurality of slave ports configured to connect to a plurality of slaves, wherein the slave ports are connected to the master ports through a plurality of data buses, each of the master ports has a fixed priority for accessing to the slave port;
a plurality of first multiplexers and a plurality of second multiplexers connected between the master ports and the slave ports, wherein the first multiplexers and the second multiplexers are configured to perform switching between the master ports and the slave ports;
a plurality of decoders connected to the second multiplexers, wherein each of the decoders is configured to receive and decode an address signal sent by the master port and generate a corresponding selection signal, the second multiplexer selects the corresponding slave port to connect to the master port according to the selection signal;
a plurality of arbiters connected to the first multiplexers, wherein each of the arbiters is configured to receive a request signal sent by the master port, and determine an order in which the master ports access to the slave port according to a means combined with the fixed priority and a first-come-first-served basis.

2. The device for accessing data bus of claim 1, wherein when more than one master ports simultaneously request access to the same slave port, the arbiter determines the order in which the master ports access to the slave port according to the fixed priority, the master port with the higher priority is granted access to the slave port.

3. The device for accessing data bus of claim 2, wherein when more than one master ports request access to the same slave port non-simultaneously, the arbiters determine the order in which the master ports access to the slave port according to the first-come-first-served basis, the master port which requests access to the same slave port at the earliest time is granted the higher accessing priority to the slave port.

4. The device for accessing data bus of claim 1, wherein the number of the master ports is N, which comprises a first master port, a second master port, . . . , until a Nth master port, and the corresponding priority levels are a first level, a second level, . . . , until a Nth level, the fixed priority of the master ports for accessing to the slave ports is in the order the first level>the second level>, . . . , >the Nth level, if the Mth master port requests access to the same slave port before the M−1th master port, the arbiter determines the Mth master port to have preferential access to the slave port according to the first-come-first-served basis until the Mth master port stops requesting to use the data bus, the arbiter then determines the order in which the first master port, the second master port, . . . , until the M−1th master port accesses to the slave port according to the fixed priority, wherein N and M are integer numbers, M is greater than or equal to 1, and less than or equal to N.

5. A method for accessing data bus for a system, the system comprising a plurality of master ports and a plurality of slave ports connected to the plurality of master ports through data buses, wherein the master ports have a fixed priority for accessing to the slave port, the method comprising:
receiving and decoding an address signal sent by the master port, generating a corresponding selection signal, and selecting the corresponding slave port to connect to the master port according to the selection signal; and
receiving a request signal sent by the master port, and determining an order in which the master ports access to the slave port according to a means combined with the fixed priority and a first-come-first-served basis.

6. The method for accessing data bus of claim 5, wherein when more than one master ports simultaneously request access to the same slave port, the arbiter determines the order in which the master ports access to the slave port according to the fixed priority, the master port with the higher priority is granted access to the slave port.

7. The method for accessing data bus of claim 6, wherein when more than one master ports request access to the same slave port non-simultaneously, the arbiters determine the order in which the master ports access to the slave port according to the first-come-first-served basis, the master port which requests access to the same slave port at the earliest time is granted the higher accessing priority to the slave port.

8. The method for accessing data bus of claim 5, wherein the number of the master ports is N, which comprises a first master port, a second master port, . . . , until a Nth master port, and the corresponding priority levels are a first level, a second level, . . . , until a Nth level, the fixed priority of the master ports for accessing to the slave ports is in the order the first level>the second level>, . . . , >the Nth level, if the Mth master port requests to access to the same slave port before the M−1th master port, the arbiter determines the Mth master port to have preferential access to the slave port according to the first-come-first-served basis until the Mth master port stops requesting to use the data bus, the arbiter then determines the order in which the first master port, the second master port, . . . , until the M−1th master port accesses to the slave port according to the fixed priority, wherein N and M are integer numbers, M is greater than or equal to 1, and less than or equal to N.

9. A system for accessing data bus comprising:
a plurality of masters;
a plurality of slaves; and
a device for accessing data bus comprising:
a plurality of master ports connected to the plurality of masters;
a plurality of slave ports connected to the plurality of slaves, wherein the slave ports are connected to the master ports through a plurality of data buses, each of the master ports has a fixed priority for accessing to the slave port;
a plurality of first multiplexers and a plurality of second multiplexers connected between the master ports and the slave ports, wherein the first multiplexers and the second multiplexers are configured to perform switching between the master ports and the slave ports;
a plurality of decoders connected to the second multiplexers, wherein each of the decoders is configured to receive and decode an address signal sent by the master port and generate a corresponding selection signal, the second multiplexer selects the corresponding slave port to connect to the master port according to the selection signal;
a plurality of arbiters connected to the first multiplexers, wherein each of the arbiters is configured to receive a request signal sent by the master port, and determine an order in which the master ports access to the slave port according to a means combined with the fixed priority and a first-come-first-served basis.

10. The system for accessing data bus of claim 9, wherein when more than one master ports simultaneously request access to the same slave port, the arbiter determines the order in which the master ports access to the slave port according to the fixed priority, the master port with the higher priority is granted access to the slave port.

11. The system for accessing data bus of claim 10, wherein when more than one master ports request access to the same slave port non-simultaneously, the arbiters determine the order in which the master ports access to the slave port according to the first-come-first-served basis, the master port which requests access to the same slave port at the earliest time is granted the higher accessing priority to the slave port.

12. The system for accessing data bus of claim 9, wherein the number of the master ports is N, which comprises a first master port, a second master port, . . . , until a Nth master port, and the corresponding priority levels are a first level, a second level, . . . , until a Nth level, if the Mth master port requests to access to the same slave port before the M−1th master port, the arbiter determines the Mth master port to have preferential access to the slave port according to the first-come-first-served basis until the Mth master port stops requesting to use the data bus, the arbiter then determines the order in which the first master port, the second master port, . . . , until the M−1th master port accesses to the slave port according to the fixed priority, wherein N and M are integer numbers, M is greater than or equal to 1, and less than or equal to N.
